(19) United States
(12) Patent Application Publication
(10) Pub. No.: US 2019/0080113 A1
(43) Pub. Date: Mar. 14, 2019

(54) APPARATUS FOR RECOMMENDING USER'S PRIVACY CONTROL AND METHOD FOR THE SAME

(71) Applicant: Electronics and Telecommunications Research Institute, Daejeon (KR)

(72) Inventors: Seung-Hyun KIM, Daejeon (KR); Seok-Hyun KIM, Daejeon (KR); Soo-Hyung KIM, Daejeon (KR); Young-Sam KIM, Daejeon (KR); Jong-Hyouk NOH, Daejeon (KR); Sang-Rae CHO, Daejeon (KR); Young-Seob CHO, Daejeon (KR); Jin-Man CHO, Daejeon (KR); Seung-Hun JIN, Daejeon (KR); Se-Young HUH, Daejeon (KR); Jung-Yeon HWANG, Daejeon (KR)

(73) Assignee: Electronics and Telecommunications Research Institute, Daejeon (KR)

(21) Appl. No.: 16/057,066

(22) Filed: Aug. 7, 2018

(30) Foreign Application Priority Data
Sep. 13, 2017 (KR) 10-2017-0117220

(51) Int. Cl. G06F 21/62; G06N 99/00

(52) U.S. Cl. CPC G06F 21/6245; G06N 99/005

(57) ABSTRACT

Disclosed herein is an apparatus for recommending privacy control, which includes a relevant information collection unit for collecting relevant information to be used to recommend privacy control in response to a request for personal information of a user from an application; a privacy control recommendation unit for selecting privacy control to be recommended, corresponding to the request for the personal information, from a privacy control pattern of the user using the relevant information; an interface unit for providing an interface that provides information about the request and the recommended privacy control to the user and receives a selection of privacy control from the user; and a privacy control processing unit for processing the personal information of the user depending on the selected privacy control and providing the processed personal information to the application.

### CROSS REFERENCE TO RELATED APPLICATION

This application claims the benefit of Korean Patent Application No. 10-2017-0117220, filed Sep. 13, 2017, which is hereby incorporated by reference in its entirety into this application.

### BACKGROUND OF THE INVENTION

### 1. Technical Field

The present invention relates to an apparatus for recommending user's privacy control and a method for the same.

### 2. Description of the Related Art

In a mobile environment, a user may freely install and use various applications in a mobile terminal. Applications provide personalized services to a user using personal information and context information in the mobile terminal. However, anyone may develop an application, and an application developed for malicious purposes may steal and exploit the personal information of a user. Generally, users do not carefully check the permissions given to an application, and once an application is granted permissions, the application may freely access personal information without user intervention.

In response to a request for personal information from an application, a user makes a decision on privacy control with regard to the level of personal information to disclose. However, because users make different decisions on privacy control depending on individual criteria, it is difficult to recommend adequate privacy control to a user using only the past responses of the user or the responses of users who use similar applications. Also, because a mobile terminal has a limited User Interface (UI), a user may make a mistake during a privacy control decision process when the user is required to provide personal information to an application. Also, a user's decision on privacy control may change depending on changes in circumstances, or may be affected by a user's psychological change. This problem is referred to as a ‘privacy paradox’ or ‘privacy turbulence’ in the privacy protection field. Accordingly, a method for consistently responding to this problem and proposing a privacy control decision personalized for a user is required in order to recommend an adequate privacy control decision.

The above-described information about the related art has been retained by the inventors for the purpose of developing the present invention or was obtained during the process of developing the present invention. Thus, it should be appreciated that this information did not necessarily belong to the public domain before the patent filing date of the present invention.

### Documents of Related Art

(Patent Document 1) Korean Patent No. 10-1590626.

### SUMMARY OF THE INVENTION

An object of the present invention is to provide an apparatus and method for recommending privacy control suitable for a user.

Another object of the present invention is to provide an apparatus and method for recommending privacy control suitable for a current user by consistently learning the privacy control pattern of the user.

An embodiment of the present invention provides an apparatus for recommending privacy control, which includes a relevant information collection unit for collecting relevant information to be used to recommend privacy control in response to a request for personal information of a user from an application; a privacy control recommendation unit for selecting privacy control to be recommended, corresponding to the request for the personal information, from a privacy control pattern of the user using the relevant information; an interface unit for providing an interface that provides information about the request and the recommended privacy control to the user and receives a selection of privacy control from the user; and a privacy control processing unit for processing the personal information of the user depending on the selected privacy control and providing the processed personal information to the application.

Here, the relevant information may include at least one of situation information and information about the application.

Here, the situation information may include at least one of time information, place information, and user information corresponding to the requested personal information.

Here, the privacy control recommendation unit may select a situation that is closest to the relevant information from the privacy control pattern through calculation of proximity of the relevant information, thereby selecting the privacy control to be recommended.

Here, the apparatus may further include a privacy control pattern update unit for updating the privacy control pattern using the selected privacy control.

Here, the privacy control pattern update unit may incorporate the selected privacy control in the privacy control pattern through reinforcement learning.

Here, the reinforcement learning may be performed so as to maximize usefulness of the selected privacy control, and the usefulness may be a value corresponding to accuracy that is calculated by comparing the selected privacy control with the recommended privacy control.

Here, when reinforcement learning is performed, the privacy control pattern update unit may set a higher weight for a later time at which learning data is generated.

Here, the privacy control update unit may update the privacy control pattern when the selected privacy control differs from the recommended privacy control.

Here, the interface unit may provide the user with a privacy control selection list that includes options classified into one or more control levels and includes the recommended privacy control as one of the options.

Another embodiment of the present invention provides a method for recommending privacy control, which includes collecting relevant information to be used to recommend privacy control in response to a request for personal information of a user from an application; selecting privacy control to be recommended, corresponding to the request for the personal information, from a privacy control pattern of the user using the relevant information; providing an interface that provides information about the request and the recommended privacy control to the user and receives a selection of privacy control from the user; and processing the personal information of the user depending on the selected privacy control and providing the processed personal information to the application.

Here, the relevant information may include at least one of situation information and information about the application.

Here, the situation information may include at least one of time information, place information, and user information corresponding to the requested personal information.

Here, selecting the privacy control to be recommended may be configured to select a situation that is closest to the relevant information from the privacy control pattern through calculation of proximity of the relevant information, thereby selecting the privacy control to be recommended.

Here, the method may further include updating the privacy control pattern using the selected privacy control.

Here, updating the privacy control pattern may be configured to incorporate the selected privacy control in the privacy control pattern through reinforcement learning.

Here, the reinforcement learning may be performed so as to maximize usefulness of the selected privacy control, and the usefulness may be a value corresponding to accuracy that is calculated by comparing the selected privacy control with the recommended privacy control.

Here, updating the privacy control pattern may be configured to set a higher weight for a later time at which learning data is generated when reinforcement learning is performed.

Here, updating the privacy control pattern may be configured to update the privacy control pattern when the selected privacy control differs from the recommended privacy control.

Here, providing the interface may be configured to provide the user with a privacy control selection list that includes options classified into one or more control levels and includes the recommended privacy control as one of the options.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows the configuration of a system for recommending privacy control according to an embodiment of the present invention;

FIG. 2 is a block diagram that shows an example of the privacy control recommendation apparatus illustrated in FIG. 1;

FIG. 3 is a flowchart that shows a method for recommending privacy control according to an embodiment of the present invention;

FIG. 4 is a flowchart that shows an example of the step of collecting relevant information, illustrated in FIG. 3;

FIG. 5 is a flowchart that shows an example of the step of updating a privacy control pattern, illustrated in FIG. 3; and

FIGS. 6 and 7 are views that show an example of an interface provided to a user according to an embodiment of the present invention.

### DESCRIPTION OF THE PREFERRED EMBODIMENTS

Because the present invention may be variously changed and may have various embodiments, specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, and all or some of the embodiments may be selectively combined and configured, so that the embodiments may be modified in various ways. It will be understood that, although the terms “first”, “second”, etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Also, each block or step in the drawings may indicate a module, a segment, or a part of code that includes one or more executable instructions for performing a logical function (or functions) specified therein. Also, in some alternative embodiments, the functions specified in blocks or steps may be performed in a different order. For example, two consecutively illustrated blocks or steps may be performed at the same time, or occasionally, they may be performed in the reverse order depending on the corresponding function.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

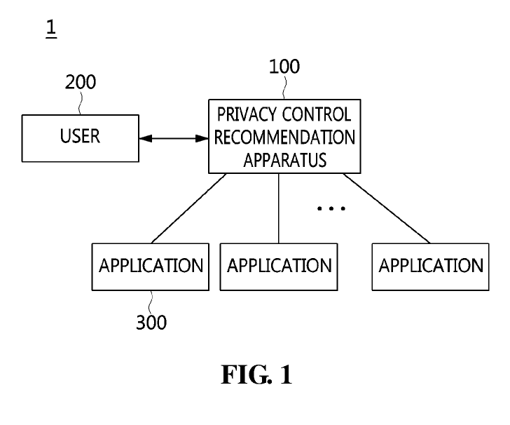

FIG. 1 is a block diagram that shows the configuration of a system 1 for recommending privacy control according to an embodiment of the present invention.

Referring to FIG. 1, in the system 1 for recommending privacy control according to an embodiment of the present invention, a privacy control recommendation apparatus 100 interacts with a user 200 and an application 300.

Here, a single privacy control recommendation apparatus 100 may interact with one or more applications 300.

Particularly, the privacy control recommendation apparatus 100 and the application 300 may be implemented so as to operate in different terminals or devices or to operate in the same terminal or device.

For example, when the application 300 is installed in and run on the smartphone of the user 200, the smartphone may function as the privacy control recommendation apparatus 100.

Specifically, in response to a request for personal information of the user 200 from the application 300, the privacy control recommendation apparatus 100 collects relevant information, selects suitable privacy control to be recommended to the user 200 using the collected relevant information, provides the recommended privacy control to the user 200, provides an interface for receiving a selection of privacy control from the user 200, processes the personal information of the user 200 depending on the privacy control selected by the user 200, and provides the processed personal information to the application 300.

Here, the privacy control recommendation apparatus 100 may select the privacy control to be recommended using a privacy control pattern.

Here, the privacy control recommendation apparatus 100 may update the privacy control pattern using the privacy control selected by the user 200. The privacy control pattern may be updated through reinforcement learning.

Particularly, for an event occurring in time series during reinforcement learning, a Temporal Difference (TD) learning method, in which a value predicted in the past is corrected based on the current behavior in order to make a more precise prediction, may be used. Through this method, the pattern of privacy control performed in the past is updated based on the privacy control performed by the user in the current situation. Accordingly, if the privacy control performed by the user is changed this time, the change is applied to the privacy control pattern so as to be used to select the privacy control to be recommended next time.

In the privacy control method using conventional machine learning, pattern learning is performed only when all learning data is prepared. However, the present invention may create a privacy control pattern using learning data that is available up to the present time through reinforcement learning and may select the privacy control to be recommended based on the privacy control pattern. Also, the privacy control pattern may be updated in real time whenever learning data is added.

That is, the privacy control recommendation apparatus 100 selectively provides personal information depending on the purpose of use of an application service and the service level in consideration of the application usage pattern, thereby operating so as to improve the usability of the service while protecting privacy.

A detailed description of the privacy control recommendation apparatus 100 will be made later.

The user 200 is a person who uses the application 300, and may be the user of a terminal or device on which the application 300 is run. Also, the user 200 is a person who uses the privacy control recommendation apparatus 100.

Here, it is desirable that the terminal used by the user 200 be a mobile terminal, such as smartphone, a wearable device that is capable of voice/video calls, a tablet PC, a laptop, or the like, but the terminal is not limited to these examples. Depending on the circumstances, the terminal may include a wired terminal, such as a desktop PC, another communication device, or the like. Such a user terminal may support wireless Internet communication, such as Wi-Fi, WiBro, and the like, mobile communication, such as WCDMA, LTE, and the like, Wireless Access in Vehicular Environment (WAVE), wired internet communication, and the like depending on a communication environment. Also, the terminal used by the user 200 is configured such that an operating platform may perform overall management and operation of the terminal. The operating platform may be an Operating System (OS), and may store programs, data, and the like for the overall management and operation of the user terminal in storage and manage the same, control the execution of a program that is necessary for the operation of the user terminal and the display thereof, and store the personal information of the user in the storage and manage the same. It is desirable that the operating platform be installed in the user terminal and run thereon, but the operating platform may operate in a device outside the user terminal depending on the circumstances.

The application 300 may be any of various kinds of applications or services for providing various functions by being run on the terminal or device of a user. Here, the type of the application 300 is not limited. That is, the application may have various functions and types, for example, an app for online banking, an app for credit card payment, an online shopping app, an app for a chauffeur service, and the like, so that a corresponding service is provided for the purpose.

Here, the application 300 in the form of a program may be installed in and run on the terminal of the user, but the application 300 may be run without installation in the terminal by taking the form of a web page or the like.

Here, the application 300 may request various kinds of personal information from the user 200 in order to provide the designed function.

Here, the request for personal information from the application 300 may be made by requesting permissions for allowing access to personal information stored in the terminal of the user 200.

For example, the application 300 may request location information, contacts, account information, pictures, files, sensor information, and the like as the personal information of the user 200.

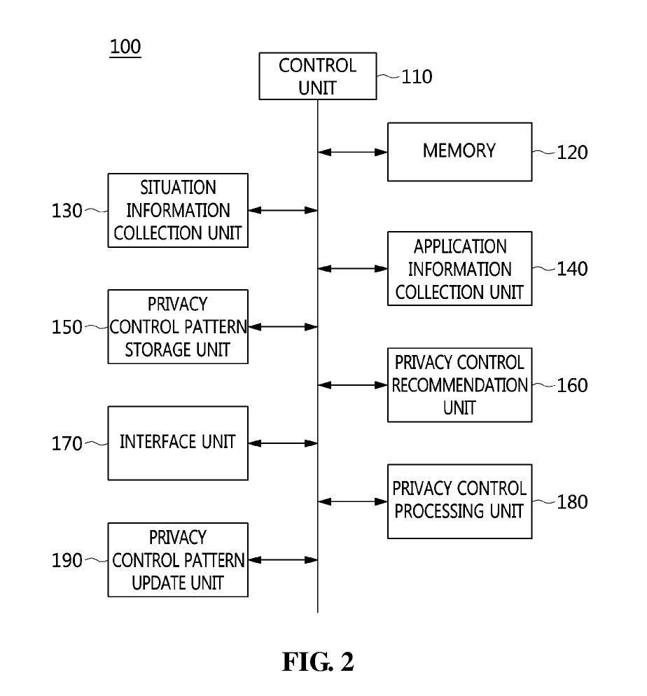

FIG. 2 is a block diagram that shows an example of the privacy control recommendation apparatus 100 illustrated in FIG. 1.

Referring to FIG. 2, the privacy control recommendation apparatus 100 according to an embodiment of the present invention includes a control unit 110, a communication unit, memory 120, a situation information collection unit 130, an application information collection unit 140, a privacy control pattern storage unit 150, a privacy control recommendation unit 160, an interface unit 170, a privacy control processing unit 180, a privacy control pattern update unit 190, and the like.

Specifically, the control unit 110 is a kind of central processing unit, and controls the overall process of recommending privacy control. That is, the control unit 110 may provide various functions by controlling the situation information collection unit 130, the application information collection unit 140, the privacy control pattern storage unit 150, the privacy control recommendation unit 160, the interface unit 170, the privacy control processing unit 180, the privacy control pattern update unit 190, and the like.

Here, the control unit 110 may include all kinds of devices capable of processing data, such as a processor or the like. Here, the term ‘processor’ may indicate, for example, a data-processing device embedded in hardware, which has a circuit physically structured for performing functions represented as code or instructions included in a program. Examples of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The communication unit provides a communication interface that is necessary in order to send and receive signals between the privacy control recommendation apparatus 100 and other devices.

Here, the communication unit may be a device including hardware and software that are necessary in order to send and receive signals, such as control signals or data signals, to and from another network device through wired or wireless connection therewith.

Here, when the privacy control recommendation apparatus 100 and the device for running the application (300 in FIG. 1) are separate from each other, the privacy control recommendation apparatus 100 may communicate with the device for running the application through the communication unit.

The memory 120 functions to temporarily or permanently store data processed by the control unit 110. Here, the memory 120 may include magnetic storage media or flash storage media, but the present invention is not limited thereto. For example, the memory 120 may include Read-Only Memory (ROM) and Random Access Memory (RAM).

The situation information collection unit 130 collects situation information as relevant information to be used to select the privacy control to be recommended in response to a request for personal information from the application. Here, the situation information may be information about the situation at the time of receiving the request for personal information.

Here, the situation information collection unit 130 may collect time information, place information, user information, demographic information, and the like as situation information. Here, the time information may include information such as whether the current day is a weekday or the weekend, whether the current time falls within working hours, non-working hours, the morning, afternoon, evening, or night, or a specific time. The place information may include a city name, a street name, a street address, and the like. The user information may include an identifier, an age, a sex, an occupation, and the like.

The application information collection unit 140 collects application information as relevant information to be used to select the privacy control to be recommended in response to a request for personal information from the application. Here, the application information is information about the application that requested the personal information.

Here, the application information collection unit 140 may collect the name of the application, the grade thereof, the number of times the application is downloaded, the category in which the application is included, the type of personal information requested by the application, the name of the developer of the application, and the like as the application information.

The privacy control pattern storage unit 150 stores the privacy control pattern of the user (200 in FIG. 1). Here, the privacy control pattern may be the user's privacy control pattern that is learned using one or more of information about previously selected privacy control, situation information, application information, and the like. That is, the privacy control pattern may be used to predict which privacy control is to be selected by the user (200 in FIG. 1) in a certain situation

Here, the privacy control pattern may be created based on each application, but may be created based on the requested personal information.

Here, if privacy control patterns for different applications are related to the same kind of personal information, the privacy control patterns may refer to and be used by each other. Alternatively, the privacy control patterns may refer to and be used by each other only when it is determined through the comparison between applications that the applications are included in the same or a similar category (for example, a map service).

For example, assume that a privacy control pattern has been created in response to a request for location information from a first application. Here, when a second application requests location information but there is no privacy control pattern for the second application, the privacy control pattern of the first application may be used to recommend privacy control in response to the request for location information from the second application. Further, the privacy control pattern of the first or second application may refer to each other in order to recommend privacy control only when the first application and the second application are included in the same or a similar category.

The privacy control recommendation unit 160 selects privacy control to be recommended, which corresponds to the request for personal information, from the privacy control pattern stored in the privacy control pattern storage unit 150 using the collected relevant information. Here, the selected privacy control to be recommended may be privacy control that is expected to be selected by the user (200 in FIG. 1) in response to the request for personal information from the application (300 in FIG. 1) when a history of privacy control selected by the user (200 in FIG. 1) in the past is reviewed.

Here, the privacy control recommendation unit 160 calculates the proximity of the relevant information and selects the situation that is closest to the relevant information from the privacy control pattern through the proximity, thereby selecting the privacy control to be recommended. For example, when the privacy control pattern shows that a user allows access to ‘street’ level of location information for a map application during commuting hours on weekdays, if another map application requests map information during office-going hours on weekdays, the commuting hours on weekdays are selected as the closest situation, and privacy control in which access to the ‘street’ level of location information is allowed may be selected as the privacy control to be recommended.

Here, the privacy control recommendation unit 160 may calculate the proximity by measuring the similarity of the relevant information or using a clustering method.

Here, the privacy control recommendation unit 160 may calculate the proximity by applying weights to user information, situation information, and application information. For example, after the highest weight, the second highest weight, and the third highest weight are applied to the type of application, place information, and time information, respectively, points corresponding to the proximity are calculated, and the situation that gains the largest number of points may be selected as the situation closest to the current situation.

The interface unit 170 provides the user (200 in FIG. 1) with an interface for providing information about the request and recommended privacy control and receiving a selection of privacy control from the user (200 in FIG. 1). That is, through the interface, the type of personal information requested by the current application (300 in FIG. 1) and the privacy control recommended by the privacy control recommendation unit 160 may be provided to the user (200 in FIG. 1), and the privacy control selected by the user (200 in FIG. 1) may be received. Therefore, the interface unit 170 may have input and output functions. For example, the input function may be provided using various methods, such as a touch panel, a keyboard, a mouse, gesture recognition, sound recognition, eye tracking, and the like, and the output function may be provided using various display panels, sound, vibration, and the like.

Here, the interface unit 170 may provide the user (200 in FIG. 1) with a privacy control selection list, which includes options classified into one or more control levels and which includes the recommended privacy control as one of the options. For example, when the requested personal information is location information, the privacy control selection list may include options classified into one or more control levels, such as ‘GPS coordinate level’, “street address level’, ‘city level’, ‘country level’, and ‘undisclosed’ therein, and among the options, ‘street address level’ may be the recommended privacy control.

Here, the control levels may be differently set based on the type of the requested personal information, and may include a level at which no information is provided in response to a request for personal information and a level at which all of the requested information is provided. That is, depending on the selection, no personal information may be provided, all of the requested information may be provided, or some of the requested information may be provided.

Here, the interface unit 170 provides the recommended privacy control to the user (200 in FIG. 1), and may then provide the privacy control selection list when the recommended privacy control is not selected by the user. For example, when the requested personal information is location information, ‘street address level’ may be provided as the recommended privacy control. Then, when the recommended privacy control is not selected, the privacy control selection list, including ‘GPS coordinate level’, ‘street address level’, ‘city level’, ‘country level’, and ‘undisclosed’, may be provided.

The privacy control processing unit 180 processes the personal information of the user (200 in FIG. 1) depending on the selected privacy control and provides the processed personal information to the application (300 in FIG. 1). Here, the processed personal information may be delivered to the application (300 in FIG. 1) through the communication unit or an internal bus.

Here, the privacy control processing unit 180 may load the source data related to the requested personal information and process the personal information so as to be disclosed at the level set depending on the selected privacy control. For example, when the requested personal information is location information and when the selected privacy control is ‘country level’, only country information may be extracted from source data collected using the actual GPS coordinates, and the extracted country information may be provided as the personal information.

The privacy control pattern update unit 190 updates a privacy control pattern using the selected privacy control.

Here, the privacy control pattern update unit 190 may incorporate the selected privacy control in the privacy control pattern through reinforcement learning.

Here, the privacy control pattern update unit 190 may incorporate the selected privacy control in the privacy control pattern through reinforcement learning using the following Equation (1):

Q(s₁, a)←Q(sᵢ, a)+α[r+γmax Q(sᵢ, a)−Q(sᵢ, a)] (1)

where α, r and γ denote parameters, sᵢ, denotes a current time point, sᵢ₊₁ denotes the next time point, ‘a’ denotes specific privacy control that is selected, and Q(sᵢ, a) denotes the usefulness of the selected privacy control ‘a’ at the current time point sᵢ.

Here, the parameters may be set to predetermined values, and may be corrected during learning.

Here, Q(sᵢ, a), which denotes usefulness, may be set so as to correspond to the accuracy or proximity of the recommended privacy control provided at the current time relative to ‘a’, which is the selected privacy control. For example, when the recommended privacy control matches the selected privacy control, accuracy is highest, and the highest usefulness may be realized. When a third privacy control level is selected from a privacy control selection list, which includes five privacy control levels, although a fifth privacy control level is recommended, the accuracy is decreased by two levels, which is the difference between the fifth level and the third level, and the usefulness may also be decreased. That is, learning is performed so as to maximize usefulness, whereby privacy control that is likely to be selected by a user may be recommended.

Here, when the privacy control pattern is updated using Equation (1), the usefulness is not calculated at sᵢ at which privacy control is selected in response to a request for personal information, but the calculation of the usefulness may be delayed until sᵢ₊₁, at which the application makes the next request for the personal information of the user. Accordingly, Q(sᵢ, a), which is the usefulness of ‘a’, which is the privacy control selected by the user in the current situation sᵢ, may be corrected in consideration of max Q(sᵢ₊₁, a), which is the maximum usefulness of the privacy control selected in the next situation s₊₁.

Here, when it performs reinforcement learning, the privacy control pattern update unit 190 may set a higher weight for a later time at which learning data is generated. That is, the weight of more recent learning data may be set higher.

Here, the privacy control pattern update unit 190 may update the privacy control pattern when the recommended privacy control differs from the selected privacy control. That is, when the user (200 in FIG. 1) selects the recommended privacy control provided by the privacy control recommendation apparatus 100, the privacy control pattern may not be updated.

When a learning process is performed in order to draw a privacy control pattern, the conventional privacy control recommendation method takes all of the previous privacy control as learning data. Accordingly, a lot of computing resources and learning time are consumed when a new privacy control response is relearned. Also, because the conventional privacy recommendation method is configured to select the privacy control response having the highest probability in the current situation in a statistical manner, when the privacy control response of the user is sharply changed, inappropriate privacy control may be recommended until the corresponding privacy control response is incorporated in the privacy control pattern and makes a statistical difference.

However, the apparatus and method for recommending privacy control according to the present invention consistently incorporate the privacy control selected by a user in the privacy control pattern, thereby recommending personalized privacy control in which the recent tendencies of the user are reflected. Also, unlike the conventional privacy control recommendation method in which the privacy control pattern is updated by calculating all learning data, the present invention may immediately apply the currently selected privacy control to the existing privacy control pattern of the user through reinforcement learning, whereby the amount of computing resources consumed to update the privacy control pattern and time overhead may be reduced. Also, the conventional privacy control recommendation method is configured such that a privacy control pattern is changed only when the selected privacy control makes a recognizable statistical difference. However, the present invention performs learning by applying a high weight to currently selected privacy control. Accordingly, even when the privacy control pattern is sharply changed (for example, in the event of a privacy paradox or privacy turbulence), the privacy control pattern may be updated quickly, and appropriate privacy control may be recommended.

Accordingly, in response to frequent requests for personal information, the present invention recommends privacy control in consideration of the previous response patterns of a user, thereby helping the user easily perform consistent privacy control.

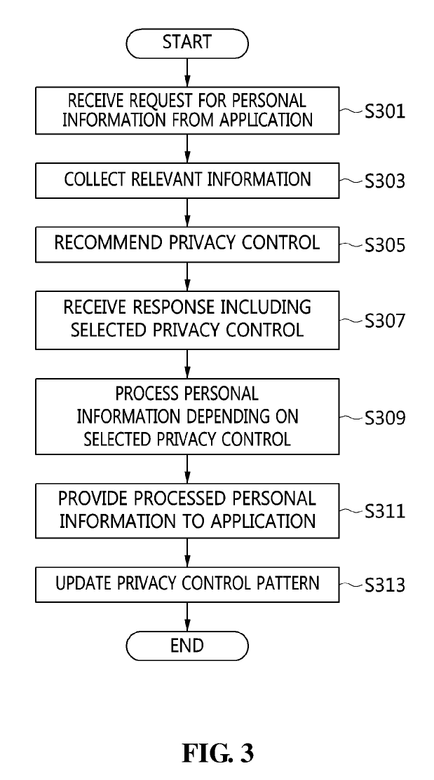

FIG. 3 is a flowchart that shows a method for recommending privacy control according to an embodiment of the present invention.

Referring to FIG. 3, in the method for recommending privacy control according to an embodiment of the present invention, the privacy control recommendation apparatus (100 in FIG. 1) receives a request for personal information from an application at step S301.

Also, in the method for recommending privacy control according to an embodiment of the present invention, the privacy control recommendation apparatus (100 in FIG. 1) collects relevant information at step S303 in response to the request for personal information.

Also, in the method for recommending privacy control according to an embodiment of the present invention, the privacy control recommendation apparatus (100 in FIG. 1) selects the privacy control to be recommended at step S305 using the collected relevant information.

Also, in the method for recommending privacy control according to an embodiment of the present invention, the privacy control recommendation apparatus (100 in FIG. 1) provides an interface including information about the request and the recommended privacy control and receives a selection of privacy control at step S307 in response to the request for personal information.

Also, in the method for recommending privacy control according to an embodiment of the present invention, the privacy control recommendation apparatus (100 in FIG. 1) processes personal information depending on the selected privacy control at step S309.

Also, in the method for recommending privacy control according to an embodiment of the present invention, the privacy control recommendation apparatus (100 in FIG. 1) provides the processed personal information to the application that requested the personal information at step S311.

Also, in the method for recommending privacy control according to an embodiment of the present invention, the privacy control recommendation apparatus (100 in FIG. 1) updates a privacy control pattern at step S313 by incorporating the selected privacy control therein.

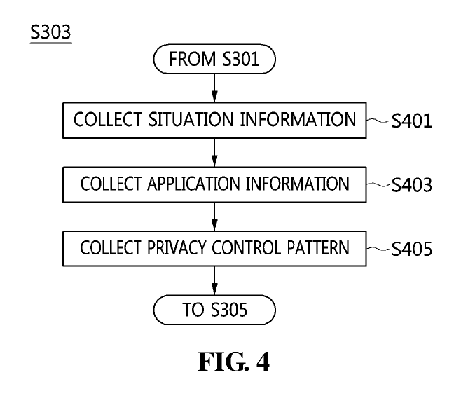

FIG. 4 is a flowchart that shows an example of the step (S303) of collecting relevant information, illustrated in FIG. 3.

Referring to FIG. 4, in the step (S303) of collecting relevant information, illustrated in FIG. 3, the privacy control recommendation apparatus (100 in FIG. 1) collects situation information corresponding to the time at which the request for personal information is made at step S401. Here, the situation information may include time information, place information, user information, demographic information, and the like.

Also, in the step (S303) of collecting relevant information, illustrated in FIG. 3, the privacy control recommendation apparatus (100 in FIG. 1) collects information about the application that requested the personal information at step S403. Here, the information about the application may include the name of the application, the grade thereof, the number of times the application is downloaded, the category in which the application is included, the type of personal information requested by the application, the name of the developer of the application, and the like.

Also, in the step (S303) of collecting relevant information, illustrated in FIG. 3, the privacy control recommendation apparatus (100 in FIG. 1) collects a privacy control pattern for a user (200 in FIG. 1) at step S405. Here, the privacy control pattern may be the user's privacy control pattern that is learned using one or more of information about the previously selected privacy control, the situation information, the application information, and the like.

Accordingly, the user may be provided with recommended privacy control that is categorized depending on the application that requested the personal information, and on the situation in which the personal information is requested.

In an alternative embodiment, among the above steps S401, S403 and S405, collecting the information about the application at step S403 may be performed before collecting the situation information at step S401.

In an alternative embodiment, among the above steps S401, S403 and S405, collecting the privacy control pattern at step S405 may be performed before collecting the information about the application at step S403.

In an alternative embodiment, among the above steps S401, S403 and S405, collecting the privacy control pattern at step S405 may be performed before collecting the situation information at step S401.

In an alternative embodiment, among the above steps S401, S403 and S405, collecting the situation information at step S401 may be performed in parallel with collecting the information about the application at step S403.

In an alternative embodiment, among the above steps S401, S403 and S405, collecting the information about the application at step S403 may be performed in parallel with collecting the privacy control pattern at step S405.

In an alternative embodiment, among the above steps S401, S403 and S405, collecting the situation information at step S401, collecting the information about the application at step S403, and collecting the privacy control pattern at step S405 may be performed simultaneously.

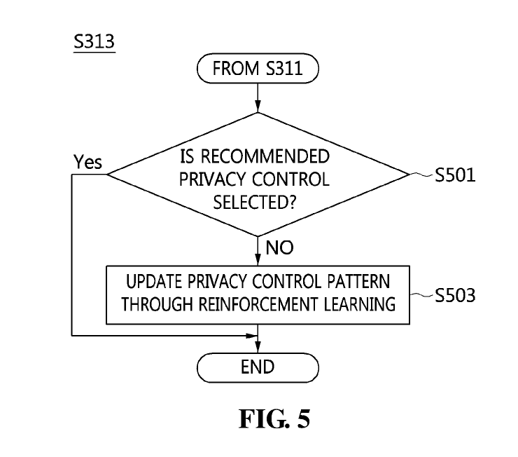

FIG. 5 is a flowchart that shows an example of the step (S313) of updating a privacy control pattern illustrated in FIG. 3.

Referring to FIG. 5, in the step (S313) of updating the privacy control pattern, illustrated in FIG. 3, whether a user selects recommended privacy control is determined at step S501.

For example, when an option corresponding to provision of ‘street’ level of location information is proposed as recommended privacy control, it is determined whether the user allows provision of a ‘street’ level of location information by selecting the recommended privacy control.

When it is determined at step S501 that the user selects the recommended privacy control, the privacy control pattern is not updated, and the process is terminated.

When it is determined at step S501 that the user does not select the recommended privacy control, the privacy control selected by the user is incorporated in the privacy control pattern through reinforcement learning, whereby the privacy control pattern is updated at step S503.

That is, the method for updating the privacy control pattern illustrated in FIG. 5 is for updating the privacy control pattern only when the selected privacy control differs from the recommend privacy control.

In another embodiment, the privacy control pattern may be updated regardless of whether the selected privacy control differs from the recommended privacy control.

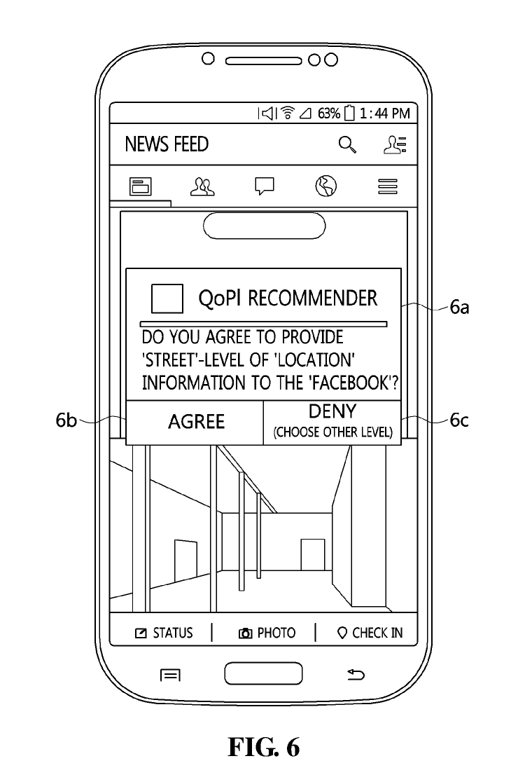

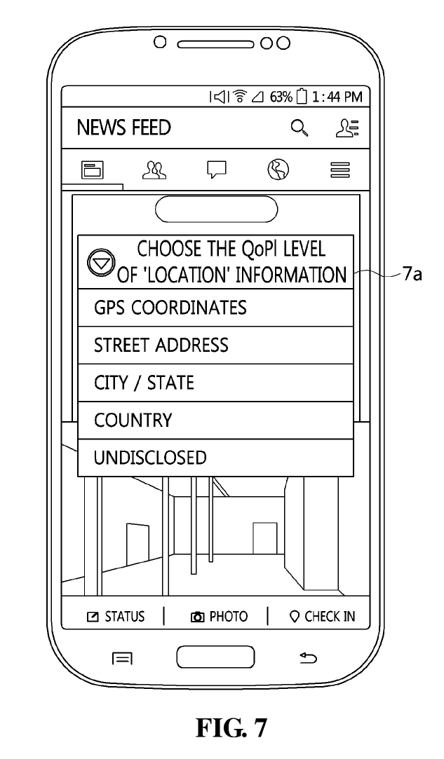

FIG. 6 and FIG. 7 are views that show an example of an interface provided to a user according to an embodiment of the present invention.

Specifically, FIG. 6 shows an example of an interface that provides recommended privacy control when an application (300 in FIG. 1) requests location information as the personal information of a user (200 in FIG. 1) according to an embodiment of the present invention. Also, FIG. 7 shows an example of an interface that is provided when the user (200 in FIG. 1) does not select the recommended privacy control in the interface illustrated in FIG. 6.

Referring to FIG. 6, when an application requests personal information of a user in the user terminal, the privacy control recommendation apparatus (100 in FIG. 1) provides the interface 6a that provides the details of the requested personal information and recommended privacy control. Also, a button 6b for agreeing with the recommended privacy control and a button 6c for denying the recommended privacy control and selecting an another level may be provided.

For example, through the interface 6a, the fact that the Facebook application requested information about the location of a user is made known to the user, and simultaneously, the street level of location information may be proposed as the recommended privacy control.

If the ‘AGREE’ button 6b is selected, the recommended privacy control is selected, and the personal information may be processed based thereon and provided to the application. If the ‘DENY’ button 6c is selected, the interface (7a in FIG. 7) that provides a privacy control selection list may be provided.

Referring to FIG. 7, when the user (200 in FIG. 1) does not select the recommended privacy control, the privacy control recommendation apparatus (100 in FIG. 1) provides the interface 7a that includes a privacy control selection list. Here, the privacy control selection list may include privacy control options that are classified into one or more control levels for the user's personal information requested by the application. Also, when the user selects one privacy control option from the privacy control selection list, personal information may be processed based thereon and provided to the application.

For example, when the application requests location information and when the user does not select the recommended privacy control, the interface 7a that provides a privacy control selection list, which includes ‘GPS coordinate level’, ‘street address level’, ‘city level’. ‘country level’, and ‘undisclosed’ as options thereof, may be provided.

Here, the privacy control selection list may include the recommended privacy control as one option thereof.

Also, when privacy control is selected from the privacy control selection list, the selected privacy control may be incorporated in the privacy control pattern, whereby the privacy control pattern may be updated.

The above-described embodiment of the present invention may be implemented as program instructions executable by various computer components, and may be recorded in computer-readable storage media. The computer-readable storage media may separately or collectively include program instructions, data files, data structures, and the like. The program instructions recorded in the computer-readable storage media may be specially designed and configured for the embodiment, or may be available due to being well known to computer software experts. Examples of the computer-readable storage media include magnetic media such as a hard disk, a floppy disk and a magnetic tape, optical media such as a CD-ROM and a DVD, magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations according to the present invention and vice-versa.

According to the present invention, a user may easily perform consistent privacy control through an apparatus and method for recommending privacy control to a user.

Also, according to the present invention, the privacy control pattern of a user is consistently learned through the apparatus and method for recommending privacy control to a user, whereby, even when the privacy control pattern of the user is sharply changed, suitable privacy control in which the change is reflected may be recommended.

Although specific embodiments have been described in the specification, they are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. An apparatus for recommending privacy control, comprising:
a relevant information collection unit for collecting relevant information to be used to recommend privacy control in response to a request for personal information of a user from an application;
a privacy control recommendation unit for selecting privacy control to be recommended, corresponding to the request for the personal information, from a privacy control pattern of the user using the relevant information;
an interface unit for providing an interface that provides information about the request and the recommended privacy control to the user and receives a selection of privacy control from the user; and
a privacy control processing unit for processing the personal information of the user depending on the selected privacy control and providing the processed personal information to the application.

2. The apparatus of claim 1, wherein the relevant information includes at least one of situation information and information about the application.

3. The apparatus of claim 2, wherein the situation information includes at least one of time information, place information, and user information corresponding to the requested personal information.

4. The apparatus of claim 3, wherein the privacy control recommendation unit selects a situation that is closest to the relevant information from the privacy control pattern through calculation of proximity of the relevant information, thereby selecting the privacy control to be recommended.

5. The apparatus of claim 4, further comprising:
a privacy control pattern update unit for updating the privacy control pattern using the selected privacy control.

6. The apparatus of claim 5, wherein the privacy control pattern update unit incorporates the selected privacy control in the privacy control pattern through reinforcement learning.

7. The apparatus of claim 6, wherein the reinforcement learning is performed so as to maximize usefulness of the selected privacy control, wherein the usefulness is a value corresponding to accuracy that is calculated by comparing the selected privacy control with the recommended privacy control.

8. The apparatus of claim 7, wherein, when reinforcement learning is performed, the privacy control pattern update unit sets a higher weight for a later time at which learning data is generated.

9. The apparatus of claim 8, wherein the privacy control update unit updates the privacy control pattern when the selected privacy control differs from the recommended privacy control.

10. The apparatus of claim 9, wherein the interface unit provides the user with a privacy control selection list that includes options classified into one or more control levels and includes the recommended privacy control as one of the options.

11. A method for recommending privacy control, comprising:
collecting relevant information to be used to recommend privacy control in response to a request for personal information of a user from an application;
selecting privacy control to be recommended, corresponding to the request for the personal information, from a privacy control pattern of the user using the relevant information;
providing an interface that provides information about the request and the recommended privacy control to the user and receives a selection of privacy control from the user; and
processing the personal information of the user depending on the selected privacy control and providing the processed personal information to the application.

12. The method of claim 11, wherein the relevant information includes at least one of situation information and information about the application.

13. The method of claim 12, wherein the situation information includes at least one of time information, place information, and user information corresponding to the requested personal information.

14. The method of claim 13, wherein selecting the privacy control to be recommended is configured to select a situation that is closest to the relevant information from the privacy control pattern through calculation of proximity of the relevant information, thereby selecting the privacy control to be recommended.

15. The method of claim 14, further comprising:
updating the privacy control pattern using the selected privacy control.

16. The method of claim 15, wherein updating the privacy control pattern is configured to incorporate the selected privacy control in the privacy control pattern through reinforcement learning.

17. The method of claim 16, wherein the reinforcement learning is performed so as to maximize usefulness of the selected privacy control,
wherein the usefulness is a value corresponding to accuracy that is calculated by comparing the selected privacy control with the recommended privacy control.

18. The method of claim 17, wherein updating the privacy control pattern is configured to set a higher weight for a later time at which learning data is generated when reinforcement learning is performed.

19. The method of claim 18, wherein updating the privacy control pattern is configured to update the privacy control pattern when the selected privacy control differs from the recommended privacy control.

20. The method of claim 19, wherein providing the interface is configured to provide the user with a privacy control selection list that includes options classified into one or more control levels and includes the recommended privacy control as one of the options.
